(19) United States
(12) Patent Application Publication
(10) Pub. No.: US 2025/0271213 A1
(43) Pub. Date: Aug. 28, 2025

(54) CONTINUOUS, HIGH-TEMPERATURE SLAB PREHEATING PLANT FOR FLAT SEMI-FINISHED STEEL PRODUCTS

(71) Applicants: SMS GROUP S.P.A., Tarcento (Udine) (IT); SSAB EMEA AB, Oxelösund (SE)

(72) Inventors: Pietro DELLA PUTTA, Tarcento (Udine) (IT); Jimmy FABRO, Tarcento (Udine) (IT); Jan STENINGER, Nyköping (SE)

(21) Appl. No.: 19/055,992

(22) Filed: Feb. 18, 2025

(30) Foreign Application Priority Data
Feb. 23, 2024 (EP) 24159338.3

(51) Int. Cl. F27B 9/02; C21D 1/40; C21D 1/42; C21D 9/46; F27B 9/06

(52) U.S. Cl. CPC F27B 9/028; C21D 1/40; C21D 1/42; C21D 9/46; F27B 9/063; F27B 9/067

(57) ABSTRACT

A continuous, high-temperature preheating plant for preheating flat semi-finished steel products has a conveying line suitable to transfer the flat semi-finished steel products from an inlet to an outlet of the continuous, high-temperature preheating plant, and a plurality of heating devices arranged along the conveying line to heat the semi-finished steel products from an inlet temperature to a predetermined final temperature. The plurality of heating devices has, arranged in sequence between the inlet and the outlet along the conveying line, a first induction furnace, a second induction furnace, and at least one electric resistance radiation furnace. The continuous, high-temperature preheating plant has a cutting apparatus suitable to cut a starting flat semi-finished steel product into a plurality of cut segments having a predetermined length less than a length of the starting flat semi-finished steel product. The cutting apparatus is arranged between the first induction furnace and the second induction furnace.

### CROSS REFERENCE TO RELATED APPLICATION

This application claims priority to and benefit of European Patent Application No. 24159338.3 filed Feb. 23, 2024, the contents of which are incorporated by reference in their entirety.

### FIELD OF THE INVENTION

The present invention relates to a continuous (capable of high production capacity) and high temperature (potentially capable of exceeding 1,150° C.) preheating plant for flat semi-finished steel products (slabs).

The preheating plant according to the present invention is particularly suitable to operate on large production of slabs based on small batches characterized by high dimensional variability, while maintaining high energy efficiency.

### BACKGROUND ART

The increase in carbon dioxide emissions into the atmosphere from industrial and anthropogenic sources is considered one of the most important causes of the rise in the planet's temperature due to greenhouse effect and thus of the ongoing climate change.

Carbon dioxide (CO₂) is a naturally occurring chemical compound normally found in the atmosphere, produced by the respiration of most living organisms, and along with water contained in the atmosphere in gaseous (vapor) and liquid (cloud) form, contributes to the greenhouse effect. While the water content of the Earth is fairly constant over time, the level of carbon dioxide can vary due to natural causes (such as temperature changes caused by solar activity or volcanic eruptions) or anthropogenic causes, mainly related to the combustion of fossil fuels such as coal, natural gas and so on.

From prehistoric times to the present, the level of carbon dioxide in the atmosphere has gone from about 280 ppm to more than 420 ppm; the cause of the rise is related to the enhancement of industrial activity, and thus its presence in the atmosphere can be reduced only by acting on industrial processes. This goal was implemented in the Kyoto Protocol, drawn up in 1995 and in force since 2005, and involves the industry for a complete long-term elimination of carbon emission sources.

In industrial preheating plants, aiming at preheating semi-finished products to the temperature required for rolling or other hot plastic deformation process, the complete elimination of CO₂ emissions can be achieved essentially according to two different manners:
by replacing fossil fuel with another carbon-free fuel, typically hydrogen, obtained through CO₂-free generation paths; or
by replacing combustion with a different heat source, typically electricity.

The first method includes replacing carbon-based fuels with pure hydrogen, i.e., the only fuel not producing carbon dioxide emissions. Burners powered by hydrogen or a mixture of natural gas and hydrogen have already been developed and are on the market today; however, to generate hydrogen, a portion of fossil-free energy is lost in conversion, with efficiencies usually ranging from 0.5 to 0.8.

The second method requires passing through industrial processes aimed at directly converting electricity into heat, which are listed below:
A. Induction Heating,
B. Direct Resistance Heating, and
C. Radiation Resistance Heating.

### Induction Heating

Through induction heating, heat is generated directly in the material by the action of an eddy current.

If the semi-product (=workpiece) is exposed to an alternating magnetic field, an eddy current will be generated close to its surface (alternating/sinusoidal current). The current flow inside the workpiece causes internal heating according to Joule's law.

Induction heating has the feature of being very fast and efficient at low temperatures.

However, such a technology has several technical problems.

A first problem is that the configuration of induction heaters necessarily includes open gaps between the coils, where the semi-finished product rests on rollers that also ensure the forward movement. Especially at high temperatures and with flat semi-finished products (e.g., slabs), the hot material radiates a large amount of energy into the atmosphere, drastically reducing the efficiency thereof.

Moreover, the coils, as well as the rollers and other elements, can require water cooling, which further decreases efficiency.

The typical total efficiency of induction heating, starting from semi-finished products at ambient temperature, is:
80%, when heating up to 350° C.,
55%, when heating up to 700° C.,
45%, when heating up to 1,000° C., and
<40%, when heating up to 1,200° C. (typical rolling temperature).

A second problem is that the induction coils can heat the material quickly, but cannot impart sufficient temperature homogeneity to the slabs to allow a direct rolling path; indeed, the slabs need sufficient waiting time to acquire the appropriate temperature uniformity throughout their thickness.

The two problems set forth above rule out the possibility of induction heating being used as the sole heating source in a preheating plant for flat semi-finished products.

### Direct Resistance Heating

Direct resistance heating consists in flowing a high electric current inside the semi-finished product by direct contact with resistive elements (terminals), one functioning as the anode and the other as the cathode.

The system requires a gripper design to provide an adequate contact surface area with all end parts of the semi-finished product so as to induce current flow through the entire section of the semi-finished product.

This system has the advantage of heating each semi-finished product in a relatively short time, providing more uniform heating than induction (because the current passes through the entire inner section), and having an overall efficiency of 70% to 80%.

However, this technology also has several technical problems.

A first problem is that although the heating process is rapid, the equipment setup requires a considerable amount of time to handle the semi-finished product, and the overall production speed is relatively modest compared to that of conventional heating furnaces or even induction heating systems.

A second problem is that the heating of flat semi-finished products (in particular slabs) would require a clamping system that is difficult to design and implement.

The two problems set forth above rule out the possibility of direct resistance heating having any application in high-capacity preheating plants for flat semi-finished products.

### Radiation Resistance Heating

Radiation resistance heating consists in using electric resistance elements to heat a closed heating chamber lined with refractory insulating material (e.g., “electric furnace”), with the result that both the resistances and the refractory surface, heated at a high temperature, radiate their energy to the semi-finished product. The resistive elements, made of heat-resistant, conductive material, both metal and ceramic, can be embedded in a refractory sheet, thus forming a “radiant panel”.

This type of technology has traditionally been applied for laboratory and small furnaces, but very rarely for high-capacity heating furnaces which operate continuously, due to several problems. The advantage of a totally closed and insulated chamber results in excellent efficiency (from 80% to 85%).

However, this technology also has several technical problems.

A first problem is that the radiant resistance panels have a lower power density than that generated by the previously described power-to-heat systems or traditional combustion burners, as can be seen from the data below:
Metal resistance (e.g., Fe—Cr—Al) panels: 20-30 kW/m²,
Ceramic resistance (e.g., MoSi2) panels: 120-150 kW/m²,
Heating furnace with combustion burners: 150-200 kW/m².

Radiation preheating is an inherently slower method than the other two methods disclosed, and even more so because of the limited power density compared to traditional combustion furnaces; therefore, a resistance preheating furnace tends to be longer and thus has a larger plan size.

This, however, at least has the advantage of good temperature homogeneity within the semi-finished products.

A second problem is that, in a conventional combustion furnace, the products of combustion contribute to creating an inert and thus non-oxidizing atmosphere, the O₂ content typically being less than 1%. However, in the absence of combustion, the free atmosphere present in the electrically heated furnace can cause increased oxidation of the semi-finished product, especially for carbon and low-alloy steels.

A third problem is that, in a typical steel slab rolling mill, there is a high variety of slab lengths to be loaded into the furnace: this results in a rather poor fill factor inside the furnace and thus a loss of efficiency.

A fourth problem is that in a plate rolling mill, working with a wide variety of slabs having different geometry and steel grade and with small batches of slabs with similar features, a typical large chamber of a walking beam or movable hearth furnace is not very flexible in accommodating the different batches and giving each batch the most suitable heating conditions, because slabs of different thickness or steel grade can be placed side by side. Or, in order to meet each individual optimal heating condition, voids must be created in the furnace to keep the slabs of different geometry and/or composition apart, thus decreasing the fill factor and thus efficiency.

A fifth problem is that the alloy steel slabs can be subject to cracking due to thermal cutting in the child slabs. The supply of heat into the cutting zone in a cold slab can cause high stresses and induce cracks in the slab itself, which leads to waste and yield losses in the rolled parent slabs.

A sixth problem is that the slabs for these types of sheet metal rolling plants can have combinations of high thicknesses (>200 mm) and high temperatures (>1,150° C.), making the roller furnace heating solution inapplicable.

Finally, a seventh problem is that the resistance heating panels, which form the first insulating layer inside the furnace, cannot be extracted from outside the furnace for replacement.

The technological solutions available to date are not suitable for application in preheating plants for flat semi-finished products (slabs) for the reasons set forth above.

Thus, in the field of preheating plants for flat semi-finished products (slabs), the need to replace combustion heating devices with electric devices, in particular with radiation resistance heating devices, is still completely unmet.

### SUMMARY OF THE INVENTION

Therefore, it is the object of the present invention to eliminate, or at least mitigate, the aforementioned problems relating to the prior art by providing a continuous, high-temperature preheating plant for flat semi-finished steel products (slabs) which, while using radiation resistance heating devices to ensure high energy efficiency, is more compact than conventional plants.

It is a further object of the present invention to provide a continuous, high-temperature preheating plant for flat semi-finished steel products (slabs) which allows avoiding the occurrence of cracks in the slabs after cutting without losing the compactness of the plant.

It is a further object of the present invention to provide a continuous, high-temperature preheating plant for flat semi-finished steel products (slabs) which has high energy efficiency even in the presence of high variability of the features of the semi-finished products to be processed.

It is a further object of the present invention to provide a continuous, high-temperature preheating plant for flat semi-finished steel products (slabs) which is operatively simple to manage.

It is a further object of the present invention to provide a continuous, high-temperature preheating plant for flat semi-finished steel products (slabs) which allows processing slabs with combinations of high thicknesses and rolling temperatures.

### DESCRIPTION OF THE DRAWINGS

The technical features of the present invention can be clearly found in the contents of the claims given below and the advantages thereof will become more apparent from the following detailed description, made with reference to the accompanying drawings, which show one or more embodiments thereof, merely given by way of non-limiting examples, in which:

FIG. 1 shows a simplified diagrammatic plan view of a continuous, high-temperature preheating plant for flat semi-finished steel products (slabs) according to a first embodiment of the present invention;

FIG. 2 shows a simplified diagrammatic plan view of a preheating plant for flat semi-finished steel products (slabs) according to a second embodiment of the present invention;

FIG. 3 shows an orthogonal elevation view of a part of the preheating plant in FIG. 1 or 2, relating to an electric resistance radiation furnace of the movable hearth type;

FIG. 4 shows an orthogonal section view of a part of the preheating plant in FIG. 1 according to plan IV-IV, relating to a plurality of electric resistance radiation furnaces of the movable hearth type;

FIG. 5 shows an enlarged view of a detail of FIG. 4, relating to the inner passage section of an electric resistance radiation furnace of the movable hearth type;

FIG. 6 shows a detail of FIG. 5 relating to the furnace structure in the upper part and on the side thereof; and

FIG. 7 shows a section view of the furnace in FIG. 5 according to plane VII-VII here indicated.

### DETAILED DESCRIPTION

With reference to the drawings, a continuous, high-temperature preheating plant for flat semi-finished steel products according to the present invention is indicated by reference numeral 1 as a whole.

By virtue of being configured to operate continuously, the preheating plant 1 is an industrial plant capable of processing high production flows (high capacity), unlike batch furnaces or laboratory plants.

The expression “high-temperature” means that the plant is potentially capable of exceeding a temperature of 1,150° C., although it can also operate at lower temperatures.

In particular, the preheating plant 1 is intended to process slabs. Hereafter in the description, the term slabs will be used as a synonym for flat semi-finished steel products.

The slabs are flat semi-finished products with a thickness generally of 50 mm or more and a width double the thickness or greater. They have a rectangular section with rounded edges and a ratio of major side to minor side less than 4 but greater than or equal to 2.

There is a high variety of slab lengths. There is also a wide variety of slabs having different steel grades which require specific optimal heating conditions.

Generally, the slabs are obtained by hot cross-cutting (orthogonally to the main longitudinal extension direction) flat semi-finished products of longer length. Hereinafter, the term “parent slab” will be used to identify the starting slab before cutting and the term “child slab” will be used to identify the individual slabs obtained by cutting a parent slab.

A main longitudinal extension axis can be identified on a slab.

The preheating plant 1 aims at preheating the slabs to the temperature required for rolling or other hot plastic deformation processes. In particular, the slabs are hot-rolled to obtain sheet metals.

According to a general embodiment of the present invention, the preheating plant 1 comprises:
a conveying line 10 suitable to transfer the flat semi-finished steel products (parent slabs) from an inlet 2 to an outlet 3 of the preheating plant 1; and
a plurality of heating devices 20, 30, 41, 42, 43, 44, 45, 46, 47, 48 arranged along the conveying line 10 to heat the semi-finished steel products/slabs from an inlet temperature Te to a predetermined final temperature Tf.

Advantageously, the movement of the semi-finished steel products/slabs inside the heating devices can be performed by the conveying line 10, if the heating devices are not provided with their own internal movement means, or can be performed by movement means integrated into the heating devices.

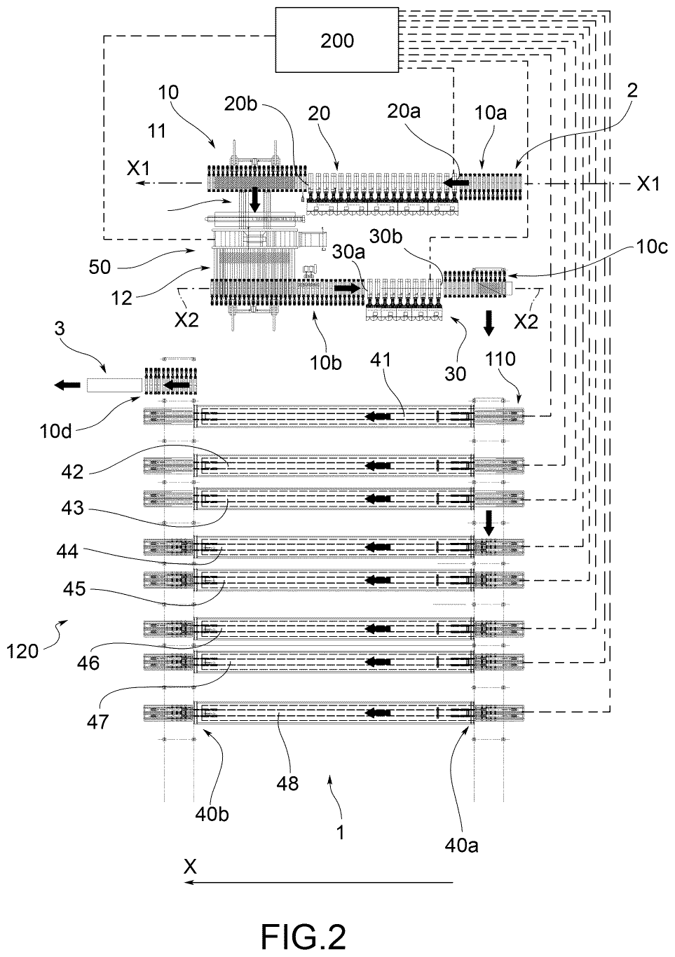

In particular, as shown in FIG. 2, the conveying line comprises a plurality of connection stretches 10a, 10b, 10c and 10d between the various devices which form the preheating plant 1. Preferably, such connection stretches consist of roller conveyor apparatuses.

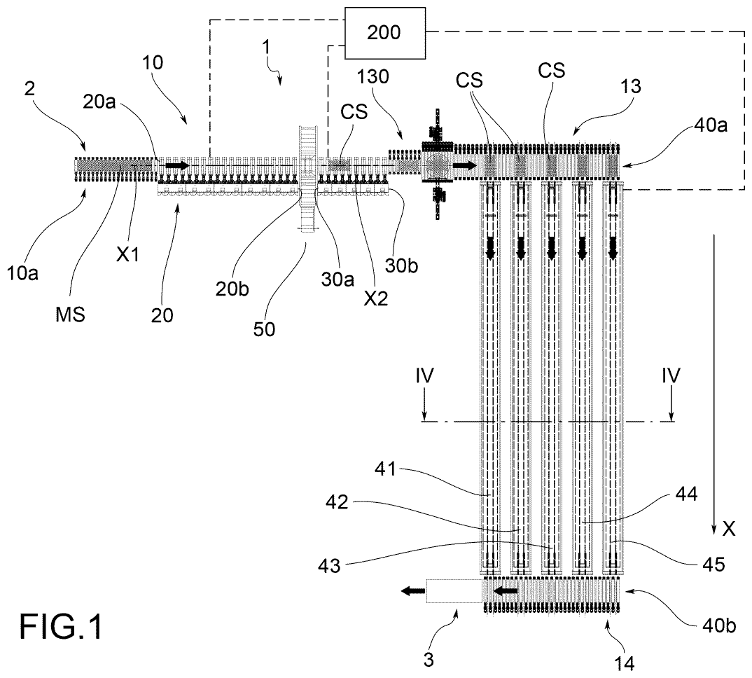

According to a first aspect of the present invention, as shown in FIGS. 1 and 2, the plurality of heating devices comprises the following devices, arranged in sequence between the inlet 2 and the outlet 3 along the conveying line 10:
a first induction furnace 20;
a second induction furnace 30; and
at least one electric resistance radiation furnace 41, 42, 43, 44, 45, 46, 47, 48.

An induction furnace and an electric resistance radiation furnace are known per se to those skilled in the art and will not be described in detail, except for possible details that differentiate them from the traditional configuration.

According to a further aspect of the present invention, the preheating plant 1 comprises a cutting apparatus 50 suitable for transversely cutting a starting flat semi-finished steel product MS (or “parent slab”) into a plurality of cut segments CS (hereinafter referred to as child slabs for simplicity) having a predetermined length less than the length of the starting flat semi-finished steel product.

A flat semi-finished product cutting apparatus is also known per se to those skilled in the art and will not be described in detail, except for any details that differentiate it from the traditional configuration.

The cutting apparatus 50 is arranged between the first induction furnace 20 and the second induction furnace 30.

In use, the first induction furnace 20 is suitable to preheat each flat semi-finished steel product MS entered in the preheating plant 1 from the inlet temperature Te to a predetermined first intermediate temperature T1m (so as to prepare it for cutting in the cutting apparatus 50), while the second induction furnace 30 is suitable to preheat each cut segment or child slab CS (exiting the cutting apparatus 50) from the predetermined first intermediate temperature T1m to a predetermined second intermediate temperature T2m.

In use, the at least one electric resistance radiation furnace 41, 42, 43, 44, 45, 46, 47, 48 is suitable to complete the preheating of the child slab CS from the predetermined second intermediate temperature T2m to the predetermined final temperature Tf.

By virtue of the present invention, the continuous, high-temperature preheating plant 1 for flat semi-finished steel products (slabs), while using radiation resistance heating devices to ensure high energy efficiency, is more compact than conventional plants.

In greater detail, such a result is achieved by virtue of the combination of induction furnaces and electric resistance radiation furnaces according to a specific arrangement whereby:
two induction furnaces provide heat to the slabs in the initial step of heating; and
at least one electric resistance radiation furnace in the final step of heating.

By virtue of the provision of part of the thermal power required for the preheating operation by the induction furnaces (less energy efficient, but faster than resistance furnaces), the amount of thermal power provided being the same, efficiency is lost, but compactness is gained.

Operatively, such configuration of the preheating plant 1 allows, during the sizing operation, favoring the compactness of the preheating plant at the expense of the energy efficiency or vice versa, depending on whether the second intermediate temperature T2m is increased or decreased.

Indeed, an induction furnace is less efficient but faster than an electric resistance radiation furnace. Therefore, with the final temperature Tf and the feature of the slab to be processed being the same, the higher the second intermediate temperature T2m, the greater the heat power fraction over the total required delivered by the induction furnace and the smaller the fraction delivered by the resistance furnace. This results in greater compactness of the plant at the expense of energy efficiency.

Conversely, the final temperature Tf and the feature of the slab to be processed being the same, the lower the second intermediate temperature T2m, the greater the heat power fraction over the total required delivered by the induction furnace and the greater the fraction delivered by the resistance furnace. This results in less plant compactness and greater energy efficiency.

Preferably, the inlet temperature Te is the ambient temperature (20° C.).

Preferably, the second intermediate temperature T2m is between 300° C. and 800° C., chosen as a function of whether the compactness of the preheating plant or its energy efficiency is to be favored.

Advantageously, the first intermediate temperature T1m is chosen as a function of the features of the material of which the semi-finished product to be cut in the cutting apparatus 50 is made.

By preheating the cold (parent) slab to a temperature above 300-350° C., the thermal shock can be minimized and the formation of cracks during the thermal cutting can be avoided.

The preheating plant according to the present invention allows avoiding the occurrence of cracks in the (child) slabs after cutting without losing the compactness of the preheating plant, because the cutting apparatus 50 is arranged between the two induction furnaces 20 and 30. The heat provided at low efficiency but quickly by such furnaces is thus utilized, without losing plant compactness.

Preferably, the preheated slabs are loaded directly into the electric resistance radiation furnace 41, 42, 43, 44, 45, 46, 47, 48 so that the energy already supplied can be preserved and thus help reduce CO₂ emissions. Preferably for such a purpose, the conveying line stretch between the second induction furnace 30 and the electric resistance radiation furnace 41, 42, 43, 44, 45, 46, 47, 48 is thermally insulated to reduce heat losses.

Advantageously, the at least one electric resistance radiation furnace 41, 42, 43, 44, 45, 46, 47, 48 defines a furnace axis X along which a cut segment or child slab CS is movable between a furnace inlet 40a and a furnace outlet 40b with the aid of movement means.

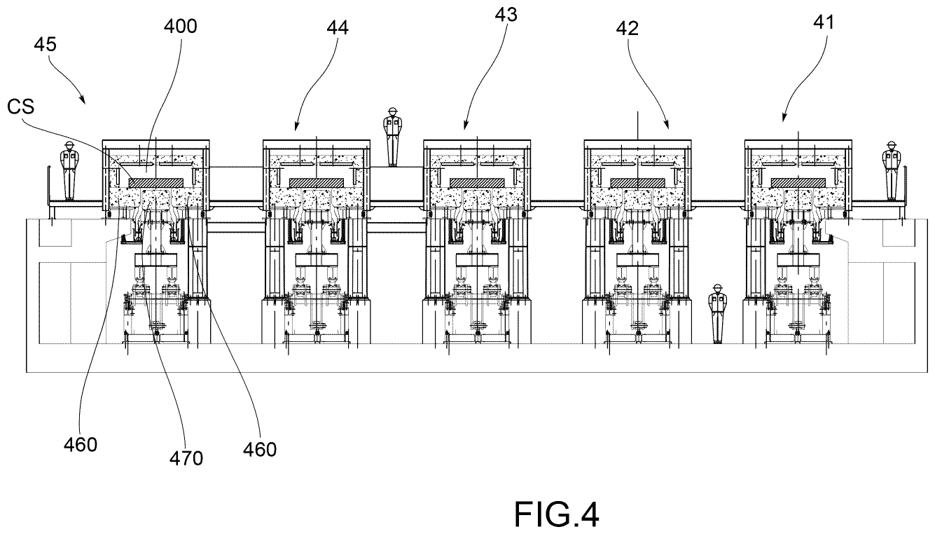

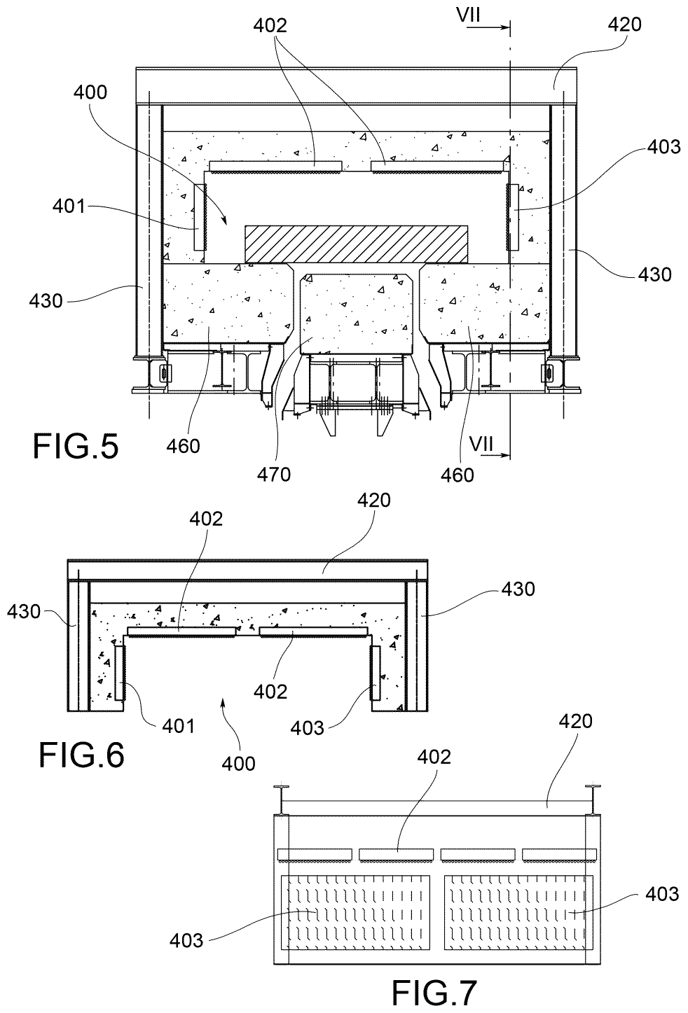

In greater detail, as shown in particular in FIGS. 4 and 5, the at least one electric resistance radiation furnace 41, 42, 43, 44, 45, 46, 47, 48 internally defines a tunnel 400 which extends along the furnace axis X between the furnace inlet 40a and the furnace outlet 40b to define the heating chamber of the furnace itself and along which a cut segment or child slab CS is movable with the aid of the movement means.

Advantageously, as shown in particular in FIGS. 5, 6, and 7, the tunnel 400 is delimited at the top and/or laterally by resistance heating panels 401, 402, 403.

Preferably, each of the resistance heating panels 401, 402, 403 is removable so as to facilitate maintenance of the preheating plant 1.

Preferably, again to facilitate maintenance of the resistance furnace, as shown in FIG. 6, the upper part of the furnace consists of a plurality of covers 420 removable from the lower structure 430.

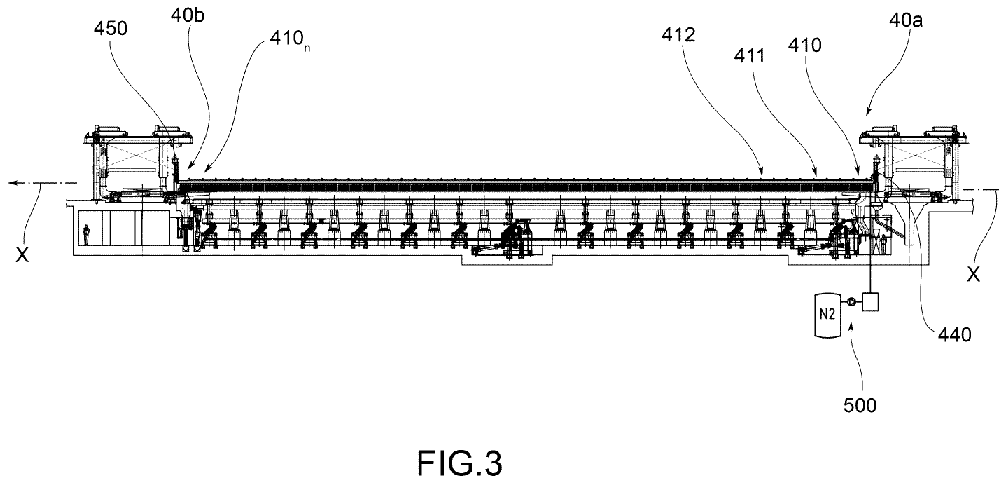

Preferably, as shown in FIG. 3, the at least one electric resistance radiation furnace 41, 42, 43, 44, 45, 46, 47, 48 consists of a plurality of modular units 410, 411, 412, . . . , 410n aligned with one another along the furnace axis X. This makes the preheating plant 1 expandable by adding additional modular units to increase the thermal capacity thereof.

Advantageously, the at least one electric resistance radiation furnace 41, 42, 43, 44, 45, 46, 47, 48 can be divided over its length along the furnace axis X into a plurality of heating zones, communicating with one another and thermally adjustable independently of one another. Each of said zones defines a temperature control zone. This provides the preheating plant 1 with high accuracy in temperature control, allowing adaptation to the specific features of the semi-finished product to be preheated.

Advantageously, the at least one electric resistance radiation furnace 41, 42, 43, 44, 45, 46, 47, 48 is provided with sealed doors at the inlet 440 and the outlet 450 and with an internal pressurization system 500 through the injection of inert gas (e.g., nitrogen) into the heating chamber of the furnace. This avoids the free atmosphere in the electrically heated furnace from causing oxidation of the semi-finished product, especially for carbon and low-alloy steels.

Preferably, the tunnel 400 of the at least one electric resistance radiation furnace 41, 42, 43, 44, 45, 46, 47, 48 has the smallest possible passage cross-section compatibly with the passage of semi-finished products (cut segments or child slabs) in order to reduce heat losses and increase furnace efficiency.

In particular, the tunnel 400 of the at least one electric resistance radiation furnace 41, 42, 43, 44, 45, 46, 47, 48 has a passage cross-section sized for the passage of a single semi-finished product/slab at a time. In other words, a single row of slabs runs along the tunnel 400.

Preferably, as shown in particular in FIGS. 3 and 4, the at least one electric resistance radiation furnace 41, 42, 43, 44, 45, 46, 47, 48 is a movable hearth furnace.

The electric resistance radiation furnace 41, 42, 43, 44, 45, 46, 47, 48 may also be a roller furnace. However, the choice of a movable hearth furnace is entirely preferred because the potential combination of slab thicknesses and heating temperature Tf does not allow the application of sufficiently strong and heat-resistant rollers. Moreover, such rollers, even where applicable, should be necessarily cooled, decreasing the efficiency of the furnace.

The electric resistance radiation furnace 41, 42, 43, 44, 45, 46, 47, 48 may also be a walking beam furnace. However, the choice of a movable hearth furnace is entirely preferred because it does not include cooled elements which are essential instead in a walking beam furnace and would reduce the efficiency of the furnace; moreover, the movable hearth furnace allows handling slabs of modest length and width with greater safety, as it provides a better support base for them.

Advantageously, in the case of a movable hearth furnace, in order to ensure the sealing of the inner furnace chamber and the outer environment, the electric resistance radiation furnace is provided with water sealing devices arranged between the fixed hearth portions 460 and the movable hearth portion 470.

Reference has been made so far to the presence of at least one electric resistance radiation furnace.

According to an entirely preferred embodiment of the invention, shown in FIGS. 1 and 2, the preheating plant 1 comprises a plurality of electric resistance radiation furnaces 41, 42, 43, 44, 45, 46, 47, 48, each of which defines a furnace axis X along which a cut segment or child slab CS is movable between a furnace inlet 40a and a furnace outlet 40b with the aid of movement means (preferably consisting of the movable hearth system).

The electric resistance radiation furnaces 41, 42, 43, 44, 45, 46, 47, 48 are inserted into the conveying line 10 in parallel with each other, after the second induction furnace 30.

Operatively, the presence of multiple resistance furnaces allows increasing not only the capacity of the preheating plant 1 in terms of production to be disposed of, but also its ability to adapt to productions characterized by high variability in the features of the semi-finished products to be processed, in terms of both length and quality of the metal.

Advantageously, each of the electric resistance radiation furnaces 41, 42, 43, 44, 45, 46, 47, 48 can be thermally adjusted independently of the other electric resistance radiation furnaces 41, 42, 43, 44, 45, 46, 47, 48 so that the cut segments CS (child slabs) processed in an electric resistance radiation furnace 41, 42, 43, 44, 45, 46, 47, 48 can exit preheated to a final temperature Tf different from those of the cut segments CS processed in the other electric resistance radiation furnaces 41, 42, 43, 44, 45, 46, 47, 48.

By virtue of this multi-furnace configuration, the preheating plant 1 continues to have high energy efficiency even with high variability in the features of the semi-finished products to be processed.

In fact, each of said resistance radiation furnaces can be dedicated to a type of slab (length and metal quality).

It is thus possible to:
achieve a fairly high fill factor inside the furnace to the advantage of efficiency;
efficiently manage small batches of slabs of similar quality;
in the presence of a large variety of slabs, thermally processing each type of slab in an optimal manner.

Advantageously, each of the electric resistance radiation furnaces 41, 42, 43, 44, 45, 46, 47, 48 can have the features that have been described above in connection with the at least one resistance furnace.

As shown in FIGS. 1 and 2, the first induction furnace 20 defines a first furnace axis X1 along which a flat semi-finished steel product MS (parent slab) is movable between a furnace inlet 20a and a furnace outlet 20b with the aid of movement means (preferably a roller conveyor apparatus). Similarly, the second induction furnace 30 defines a second furnace axis X2 along which a cut segment or child slab CS is movable between a furnace inlet 30a and a furnace outlet 30b with the aid of movement means (preferably a roller conveyor apparatus).

Preferably, the first induction furnace 20 and the second induction furnace 30 are arranged in the conveying line 10 with the respective furnace axes X1, X2 parallel to each other.

In particular, as described in detail below, the two induction furnaces 20, 30 can be mutually arranged so that the respective furnace axes are either offset or aligned.

According to the entirely preferred embodiment shown in FIG. 2, the first induction furnace 20 and the second induction furnace 30 are arranged on two parallel stretches of the conveying line 10, mutually offset and interconnected by the cutting apparatus 50.

Advantageously, the cutting apparatus 50 is arranged to process the flat semi-finished steel products MS (parent slabs) and the child slabs resulting from cutting with the respective longitudinal extension axes oriented parallel to the furnace axes X1, X2 of the two induction furnaces.

In this case, the conveying line 10 comprises:
first translation means 11 suitable to translate a flat semi-finished steel product MS (parent slab) exiting the first induction furnace 20 into the cutting apparatus 50; and
second translation means 12 suitable to translate the segments (child slabs) resulting from the cutting of the flat semi-finished steel product MS exiting the cutting apparatus 50 to the furnace inlet of the second induction furnace 30.

In greater detail, again according to the embodiment shown in FIG. 2, the electric resistance radiation furnaces 41, 42, 43, 44, 45, 46, 47, 48 are arranged with the respective furnace axes X parallel to each other and to the furnace axes X1, X2 of the two induction furnaces 20, 30.

In this case, the conveying line 10 comprises:
first manipulator means 110 suitable to translate the single child slab exiting the second induction furnace 30 to the furnace inlet of one of the electric resistance radiation furnaces 41, 42, 43, 44, 45, 46, 47, 48; and
second manipulator means 120 suitable to translate the single child slab exiting one of the electric resistance radiation furnaces 41, 42, 43, 44, 45, 46, 47, 48 to the outlet 3 of the preheating plant 1.

According to an alternative embodiment shown in FIG. 1, the first induction furnace 20 and the second induction furnace 30 are arranged on two stretches of the conveying line 10, aligned and interconnected by the cutting apparatus 50.

In this case, the cutting apparatus 50 is arranged so as to process the flat semi-finished steel products MS (parent slabs) and segments (child slabs) resulting from cutting with the respective longitudinal extension axes aligned with the furnace axes X1, X2 of the two induction furnaces.

In greater detail, again according to the embodiment shown in FIG. 1, the electric resistance radiation furnaces 41, 42, 43, 44, 45, 46, 47, 48 are arranged with the respective furnace axes X parallel to each other and orthogonal to the furnace axes X1, X2 of the two induction furnaces 20, 30.

In this case, the conveying line 10 comprises:
a connection stretch 13 which extends from the furnace outlet 30b of the second induction furnace 30 to the furnace inlets 40a of all the electric resistance radiation furnaces 41, 42, 43, 44, 45, 46, 47, 48; and
a rotation device 130 which is arranged on the connection stretch 13 and is suitable to rotate each individual child slab on itself so that it arrives at the furnace inlet of one of the electric resistance radiation furnaces 41, 42, 43, 44, 45, 46, 47, 48 with the respective longitudinal extension axis aligned with the furnace axis X of the electric resistance radiation furnace 41, 42, 43, 44, 45, 46, 47, 48.

In greater detail, again according to the embodiment shown in FIG. 1, the conveying line 10 comprises a child slab collection stretch 14 which extends from the furnace outlets 40b of all the electric resistance radiation furnaces 41, 42, 43, 44, 45, 46, 47, 48 to the outlet 3 of the preheating plant 1.

Advantageously, both plant configurations—with rotation device 130 (FIG. 1) or with all furnaces with parallel axes (FIG. 2)—are structured so that the semi-finished products are inserted into the different furnaces so as to always have a side section that is as constant as possible through the coils of the induction furnaces and through the cross-section of the tunnel of the resistance furnaces. This allows maximizing the fill factor of the two types of furnaces.

Preferably, the preheating plant 1 comprises an automatic control system 200 based on a material tracking program and a plurality of sensors to identify the position of each slab over time.

In particular, the automatic control system 200 is configured to control:
the first manipulator means 110 so as to position each slab at the inlet to the furnace for which it is intended; and
the second manipulator means 120 so as to pick up each slab at the outlet of the furnace in which it was processed and transfer it to the outlet 3 of the preheating plant 1.

The present invention allows achieving several advantages, some of which have already been described.

The high-capacity preheating plant 1 for flat semi-finished steel products (slabs) according to the present invention, while using radiation resistance heating devices to ensure high energy efficiency, is more compact than conventional plants, even with the same heat power to be transferred to the semi-finished products.

The continuous, high-temperature preheating plant 1 for flat semi-finished steel products (slabs) according to the present invention allows avoiding the occurrence of cracks in the slabs after cutting without losing the compactness of the plant.

The continuous, high-temperature preheating plant 1 for flat semi-finished steel products (slabs) according to the present invention has high energy efficiency even in the presence of high variability of the features of the semi-finished products to be processed.

The continuous, high-temperature preheating plant 1 for flat semi-finished steel products (slabs) according to the present invention is operatively simple to manage.

The continuous, high-temperature preheating plant 1 for flat semi-finished steel products (slabs) according to the present invention allows processing slabs with the combination of high thicknesses and rolling temperatures.

Therefore, the present invention thus devised achieves the preset objects.

Obviously, in practice, it may also take different shapes and configurations from that disclosed above, without departing from the present scope of protection.

Moreover, all details may be replaced by technically equivalent elements, and any size, shape, and material may be used according to needs.

What is claimed is:

1. A continuous, high-temperature preheating plant for preheating flat semi-finished steel products, comprising:
a conveying line suitable to transfer the flat semi-finished steel products from an inlet to an outlet of the continuous, high-temperature preheating plant; and
a plurality of heating devices arranged along the conveying line to heat the flat semi-finished steel products from an inlet temperature to a predetermined final temperature,
wherein the plurality of heating devices comprises, arranged in sequence between the inlet and the outlet along the conveying line:
a first induction furnace;
a second induction furnace; and
at least one electric resistance radiation furnace,
wherein the continuous, high-temperature preheating plant further comprises a cutting apparatus suitable to cut a starting flat semi-finished steel product into a plurality of cut segments having a predetermined length less than a length of the starting flat semi-finished steel product,
wherein the cutting apparatus is arranged between the first induction furnace and the second induction furnace,
wherein, in use, the first induction furnace is suitable to preheat each flat semi-finished steel product entered in the continuous, high-temperature preheating plant from the inlet temperature to a predetermined first intermediate temperature,
wherein, in use, the second induction furnace is suitable to preheat each cut segment of the plurality of cut segments from the predetermined first intermediate temperature to a predetermined second intermediate temperature, and
wherein, in use, the at least one resistance radiation furnace is suitable to complete preheating of a cut segment of the plurality of cut segments from the predetermined second intermediate temperature to the predetermined final temperature.

2. The continuous, high-temperature preheating plant of claim 1, wherein the inlet temperature is the ambient temperature.

3. The continuous, high-temperature preheating plant of claim 1, wherein the second intermediate temperature is between 300° C. and 800° C.

4. The continuous, high-temperature preheating plant of claim 1, wherein the at least one electric resistance radiation furnace defines a furnace axis along which the cut segment of the plurality of cut segments is movable between a furnace inlet and a furnace outlet with the aid of movement means.

5. The continuous, high-temperature preheating plant of claim 4, wherein the at least one electric resistance radiation furnace internally defines a tunnel that extends along the furnace axis between the furnace inlet and the furnace outlet to define a heating chamber of the electric resistance radiation furnace and along which the cut segment is movable with the aid of the movement means.

6. The continuous, high-temperature preheating plant of claim 5, wherein the tunnel is delimited at a top thereof and/or laterally by resistance heating panels, each of the resistance heating panels optionally being removable.

7. The continuous, high-temperature preheating plant of claim 4, wherein the at least one electric resistance radiation furnace consists of a plurality of modular units aligned with one another along the furnace axis.

8. The continuous, high-temperature preheating plant of claim 4, wherein the at least one electric resistance radiation furnace is divided over its length along the furnace axis into a plurality of heating zones communicating with one another and thermally adjustable independently of one another, each defining a temperature control zone.

9. The continuous, high-temperature preheating plant of claim 5, wherein the at least one electric resistance radiation furnace is provided with sealed doors at the inlet and outlet and with an internal pressurization system through injection of inert gas into the heating chamber.

10. The continuous, high-temperature preheating plant of claim 5, wherein the tunnel of the at least one electric resistance radiation furnace has a passage cross-section sized for passage of one cut segment at a time.

11. The continuous, high-temperature preheating plant of claim 1, wherein the at least one electric resistance radiation furnace is a movable hearth furnace.

12. The continuous, high-temperature preheating plant of claim 1, comprising a plurality of electric resistance radiation furnaces each of which defines a furnace axis along which a cut segment of the plurality of cut segments is movable between a furnace inlet and a furnace outlet with the aid of movement means, the electric resistance radiation furnaces being inserted into the conveying line in parallel with each other after the second induction furnace.

13. The continuous, high-temperature preheating plant of claim 12, wherein each of the electric resistance radiation furnaces is thermally adjustable independently of the other electric resistance radiation furnaces so that the cut segments processed in one of the electric resistance radiation furnaces can exit preheated at a final temperature different from final temperatures of the cut segments processed in the other electric resistance radiation furnaces.

14. The continuous, high-temperature preheating plant of claim 12, wherein the first induction furnace defines a first furnace axis along which a flat semi-finished steel product is movable between a furnace inlet and a furnace outlet of the first induction furnace with the aid of the movement means, and wherein the second induction furnace defines a second furnace axis along which the cut segment of the plurality of cut segments is movable between a furnace inlet and a furnace outlet of the second induction furnace with the aid of the movement means.

15. The continuous, high-temperature preheating plant of claim 14, wherein the first induction furnace and the second induction furnace are arranged in the conveying line with the respective furnace axes parallel to each other.

16. The continuous, high-temperature preheating plant of claim 15, wherein the first induction furnace and the second induction furnace are arranged on two parallel stretches of the conveying line, mutually offset and interconnected by the cutting apparatus,
wherein the cutting apparatus is arranged so as to process the flat semi-finished steel products and the cut segments with respective longitudinal extension axes oriented parallel to the furnace axes of the first and second induction furnaces,
and wherein the conveying line comprises:
first translation means suitable to translate a flat semi-finished steel product exiting the first induction furnace into the cutting apparatus; and
second translation means suitable to translate the cut segments resulting from cutting of the flat semi-finished steel product exiting the cutting apparatus to the furnace inlet of the second induction furnace.

17. The continuous, high-temperature preheating plant of claim 16, wherein the electric resistance radiation furnaces are arranged with the respective furnace axes parallel to each other and to the furnace axes of the first and second induction furnaces,
and wherein the conveying line comprises:
first manipulator means suitable to translate a single cut segment exiting the second induction furnace to the furnace inlet of one of the electric resistance radiation furnaces; and
second manipulator means suitable to translate the single cut segment exiting one of the electric resistance radiation furnaces to the outlet of the continuous, high-temperature plant.

18. The continuous, high-temperature preheating plant of claim 15, wherein the first induction furnace and the second induction furnace are arranged on two stretches of the conveying line, aligned and interconnected by the cutting apparatus, and
wherein the cutting apparatus is arranged so as to process the flat semi-finished steel products and the cut segments with respective longitudinal extension axes aligned with the furnace axes of the first and second induction furnaces.

19. The continuous, high-temperature preheating plant of claim 18, wherein the electric resistance radiation furnaces are arranged with the respective furnace axes parallel to each other and orthogonal to the furnace axes of the first and second induction furnaces,
and wherein the conveying line comprises:
a connection stretch which extends from the furnace outlet of the second induction furnace to reach the furnace inlets of all the electric resistance radiation furnaces; and
a rotation device arranged on the connection stretch and suitable to rotate each individual cut segment on itself so that it appears at the furnace inlet of one of the electric resistance radiation furnaces with the respective longitudinal extension axis aligned with the furnace axis of the electric resistance radiation furnace.

20. The continuous, high-temperature preheating plant of claim 19, wherein the conveying line comprises a cut segment collection stretch which extends from the furnace outlets of all the electric resistance radiation furnaces to the outlet of the continuous, high-temperature plant.

21. The continuous, high-temperature preheating plant of claim 1, further comprising an automatic control system, based on a material tracking program and a plurality of sensors to identify a position of each flat semi-finished steel product and/or cut segment.
